(19) United States
(12) Patent Application Publication
(10) Pub. No.: US 2015/0351029 A1
(43) Pub. Date: Dec. 3, 2015

(54) METHODS AND MECHANISMS FOR POWER SAVING AND PERFROMANCE BALANCING IN A TRANSMITTER

(71) Applicant: QUALCOMM Incorporated, San Diego, CA (US)

(72) Inventors: Balvinder SINGH, Hyderabad (IN); Ajay Kumar GAJA, Hyderabad (IN)

(21) Appl. No.: 14/627,841

(22) Filed: Feb. 20, 2015

Related U.S. Application Data
(60) Provisional application No. 62/003,249, filed on May 27, 2014.

(51) Int. Cl. H04W 52/02

(52) U.S. Cl. CPC H04W 52/0209; H04W 52/0203

(57) ABSTRACT

An example using the Bluetooth protocol may include a dynamic MTU adjustment for reduction of the probability of handshake collision and credit processing. This may also include making the Tx MTU a non-multiple of the number of remote Rx credits and adjusting the Tx MTU to a value that lets CONTINUE come before or after Credits without overlapping and prevents underflow situations. Another example may include periodically pacing the low priority traffic even during an underflow condition, thereby balancing the speed. Still another example may balance the frequency speeds, and thereby balancing power by controlling the processor load during unwanted waiting situations, and indirectly control unwanted Multiprocessor Frequency jump decision that may happen for low priority traffic conditions.

### CROSS-REFERENCE TO RELATED APPLICATION

The present Application for Patent claims the benefit of U.S. Provisional Application No. 62/003,249, entitled “METHODS AND MECHANISMS FOR POWER SAVING AND PERFORMANCE BALANCING IN A TRANSMITTER,” filed May 27, 2014, assigned to the assignee hereof and expressly incorporated herein by reference in its entirety.

### FIELD OF DISCLOSURE

This disclosure relates generally to performance improvements between two devices, and more specifically, but not exclusively, to power saving and performance balancing between a transmitter and a receiver.

### BACKGROUND

Conventionally, in device to device communication using any communication protocol, wired or wireless (e.g. Bluetooth protocol), there is high power consumption (could go up to even double in a given time, essentially under the platform design constraints explained later) when the receiving device has a low buffer and/or the transmitting device is experiencing processing delays due to the Protocol Flow control limitations (flowing in due to the slow remote device) during long data transmissions. In short, device to device data transfer using lower Rx Buffers at the remote side or processing delays at the local side causes high power consumption on the transmitter side. It is not good for the complete system to wait on a higher power leakage state and due to the low priority throttled Traffic conditions

Accordingly, there are long-felt industry needs for methods that improve upon conventional methods including the improved methods and apparatus provided hereby.

The inventive features that are characteristic of the teachings, together with further features and advantages, are better understood from the detailed description and the accompanying figures. Each of the figures is provided for the purpose of illustration and description only, and does not limit the present teachings.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

Some examples of the disclosure are directed to systems, apparatus, and methods for dynamic power savings and performance balancing for high performing transmitters against slow, throttled, or limited Rx buffered remote receivers.

In some examples of the disclosure, the system, apparatus, and method results in power savings (such as a reduction to more than half (e.g. in our case reduced from 300+mA to 150 mA) (this is design dependent on how the system sees various threads when throttled, for example, some of the threads may still consume unnecessarily under the flow stopped conditions) and performance increase (such as speeds increased more than 200 Kbits/second due to some changes in sequencing that do not violate applicable communications standards and specifications, but proposing some improvements thereof) specifically on an example—like a Bluetooth data transfer link.

In some examples of the disclosure, the system, apparatus, and method includes a) detecting and adjusting the buffers at run time so that the Control PDUs do not come at the same time thus having some processing impact; b) detecting a stoppage on the wait points like Local TX FULL Event specifically due to the remote's inability to match up to the speeds of the faster transmitting devices until the application level and then pace up or down the APPLICATION Data so that the CPU Utilization (Power Consumed) is under control of a particular scenario; and c) balancing with good speeds and power consumption by controlled transmission of the limited data even in the underflow conditions (of the hardware controllers), thereby anticipating the late flow control from the slow remote. These steps will further allow anticipation of such lags, and then regulate the speeds even if the transmission conditions are not good. The balancing and anticipation of the flow delays, from the slow remotes can put the faster transmitters in a good position to balance out Speeds Vs Performance. This can be applied to many other technologies, with variable speeds of protocol transfers (wired or wireless) and specifically on more power consuming modules; this will yield really good power save figures.

In some examples of the disclosure, the system, apparatus, and method includes conditions which lead to underflows in the traffic at intermittent intervals and sudden spurts of traffic the moment underflow stops and the flow begins.

In some examples of the disclosure, the system, apparatus, and method includes dynamically reducing the system power (such as a battery) for high performing devices or devices in high performance mode.

In some examples of the disclosure, the system, apparatus, and method includes increasing the speed and finishing the transactions with high speed and high power conditions by utilizing the unused AIR Channels (such as during induced Underflows).

In some examples of the disclosure, the system, apparatus, and method includes inter-process flow and inter device flow control of the process that causes the spurry traffic instead of constant low speed and low power stable traffic.

In some examples of the disclosure, the system, apparatus, and method includes a mobile device having: a data application module for generating data packets; a protocol stack component for transmitting the data packets to a remote device at a transmission flow rate, the protocol stack communicatively coupled to the data application module; an OBEX component for sending flow control messages, the OBEX component communicatively coupled to the data application module and the protocol stack component to send the flow control messages to the data application module and the protocol stack component; a processor for controlling a process flow of the data application module, the protocol stack component, and the OBEX component; and a governor for controlling a processor speed of the processor, wherein the OBEX component sends a data size flow control message to the data application module to control a size of the generated data packets based a number of remote transmission credits received from the remote device.

In some examples of the disclosure, the system, apparatus, and method includes a transmitter having: a transmitter for transmitting data packets to a receiver; a data transmission governor in communication with the transmitter, the data transmission governor configured to control a transmission speed of the transmitter; and a data flow component in communication with the transmitter, the data flow component configured to generate data packets for transmission and communicate the generated data packets to the transmitter for transmission.

In some examples of the disclosure, the system, apparatus, and method includes a method of communication between a local device and a remote device, the method including: controlling a microprocessor frequency jump decision component of a local device based on a controller underflow condition; controlling a processor load of the local device when a transmitter of the local device is waiting for a handshake message from a remote device; detecting the controller underflow condition at a run time; and adjusting a maximum transmission unit of the local device to reduce a probability of handshake collision and credit processing.

In some examples of the disclosure, the system, apparatus, and method includes an article of manufacture having a computer-readable storage medium having program code for controlling communication between a local device and a remote device, the program code comprising instructions that, when executed by a processor, cause the processor to perform operations comprising: controlling a microprocessor frequency jump decision component of a local device based on a controller underflow condition; controlling a processor load of the local device when a transmitter of the local device is waiting for a handshake message from a remote device; detecting the controller underflow condition at a run time; and adjusting a maximum transmission unit of the local device to reduce a probability of handshake collision and credit processing.

Other features and advantages associated with the apparatus and methods disclosed herein will be apparent to those skilled in the art based on the accompanying drawings and detailed description.

### BRIEF DESCRIPTION OF THE DRAWINGS

The accompanying drawings are presented to describe examples of the present teachings, and are not limiting. The accompanying drawings are presented to aid in the description of examples of the disclosure and are provided solely for illustration of the examples and not limitation thereof.

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary processor in accordance with some examples of the disclosure.

FIG. 2 illustrates exemplary user equipment (UE) in accordance with some examples of the disclosure.

FIG. 3 depicts an exemplary long file transfer using Bluetooth protocols.

FIG. 4 depicts an exemplary Bluetooth Transfer over RFCOMM.

FIG. 5 depicts an exemplary sequence that highlights a bottle neck.

FIG. 6 depicts an exemplary Put (final), Continue and RFCOMM Credits.

FIG. 7 depicts exemplary Continue and RFCOMM Credits.

FIG. 8 depicts exemplary OBEX and RFCOMM Tx and Rx.

FIG. 9 depicts an exemplary current on a CX Rail (Connectivity BT Line Current).

FIG. 10 depicts an exemplary voltage on a CX Rail (Connectivity BT Line Current).

FIG. 11 depicts an exemplary MTU adjustment in such a way that it avoids the parallel processing of the handshake signals.

FIG. 12 depicts an exemplary local MTU adjustment.

FIG. 13 depicts an exemplary an exemplary sequence according to some examples of the disclosure (Bluetooth Flow control taken as a pilot example)

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Methods, apparatus and systems for power saving and performance balancing between a transmitter and a receiver are provided. The exemplary methods, apparatus, and systems disclosed herein advantageously address the long-felt industry needs, as well as other previously unidentified needs, and mitigate shortcomings of the conventional methods, apparatus, and systems. For example, an advantage provided by the disclosed methods, apparatus, and systems herein is an improvement in power versus performance demands for device to device transmissions.

Various aspects are disclosed in the following description and related drawings to show specific examples relating to the disclosure. Alternate examples will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and examples disclosed herein.

The word “exemplary” is used herein to mean “serving as an example, instance, or illustration.” Any details described herein as “exemplary” is not necessarily to be construed as preferred or advantageous over other examples. Likewise, the term “examples” does not require that all examples include the discussed feature, advantage or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples only and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element. Coupling and/or connection between the elements can be physical, logical, or a combination thereof. As employed herein, elements can be “connected” or “coupled” together, for example, by using one or more wires, cables, and/or printed electrical connections, as well as by using electromagnetic energy. The electromagnetic energy can have wavelengths in the radio frequency region, the microwave region and/or the optical (both visible and invisible) region. These are several non-limiting and non-exhaustive examples.

It should be understood that the term “signal” can include any signal such as a data signal, audio signal, video signal, multimedia signal, analog signal, and/or digital signal. Information and signals can be represented using any of a variety of different technologies and techniques. For example, data, an instruction, a process step, a command, information, a signal, a bit, and/or a symbol described in this description can be represented by a voltage, a current, an electromagnetic wave, a magnetic field and/or particle, an optical field and/or particle, and any combination thereof.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims can be interpreted as “A or B or C or any combination of these elements.”

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the examples described herein, the corresponding form of any such examples may be described herein as, for example, “logic configured to” perform the described action.

In this description, certain terminology is used to describe certain features. The term “mobile device” can describe, and is not limited to, a mobile phone, a mobile communication device, a pager, a personal digital assistant, a personal information manager, a mobile hand-held computer, a laptop computer, a wireless device, a wireless modem, and/or other types of portable electronic devices typically carried by a person and/or having communication capabilities (e.g., wireless, cellular, infrared, short-range radio, etc.). Further, the terms “user equipment” (UE), “mobile terminal,” “mobile device,” and “wireless device,” can be interchangeable.

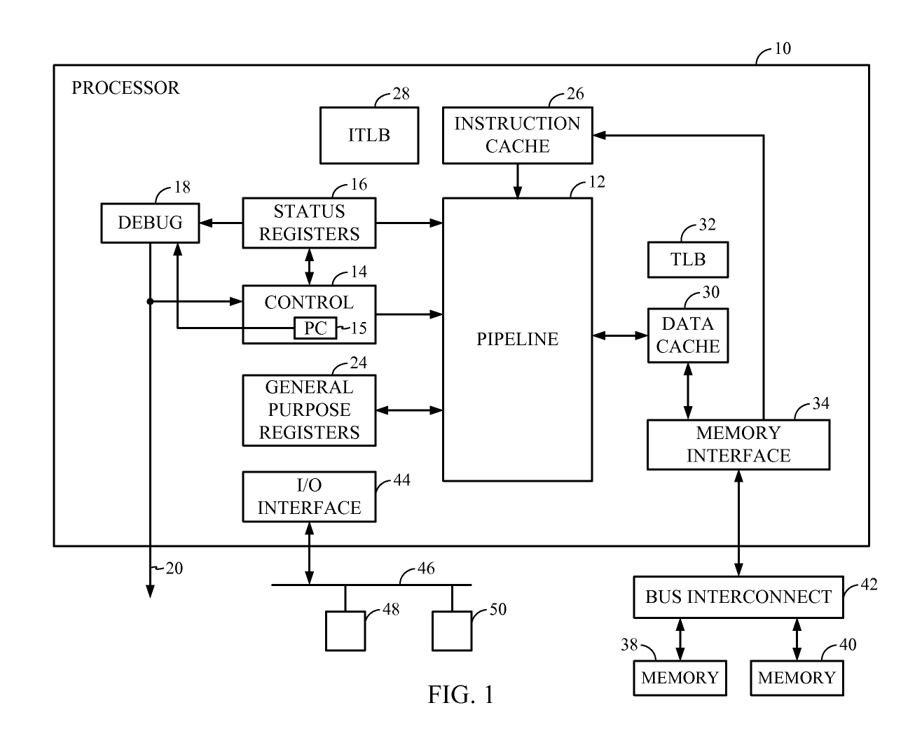

FIG. 1 depicts a functional block diagram of an exemplary processor 10, such as an ASIC 208 (see below). Processor 10 executes instructions in an instruction execution pipeline 12 according to control logic 14. Control logic 14 maintains a Program Counter (PC) 15, and sets and clears bits in one or more status registers 16 to indicate, e.g., the current instruction set operating mode, information regarding the results of arithmetic operations and logical comparisons (zero, carry, equal, not equal), and the like. In some examples, pipeline 12 may be a superscalar design, with multiple, parallel pipelines. Pipeline 12 may also be referred to as an execution unit. A General Purpose Register (GPR) file 20 provides a list of general purpose registers 24 accessible by pipeline 12, and comprising the top of the memory hierarchy.

Processor 10, which executes instructions from at least two instruction sets in different instruction set operating modes, additionally includes a debug circuit 18, operative to compare, upon the execution of each instruction, at least a predetermined target instruction set operating mode to the current instruction set operating mode, and to provide an indication of a match between the two.

Pipeline 12 fetches instructions from an instruction cache (I-cache) 26, with memory address translation and permissions managed by an Instruction-side Translation Lookaside Buffer (ITLB) 28. Data is accessed from a data cache (D-cache) 30, with memory address translation and permissions managed by a main Translation Lookaside Buffer (TLB) 32. In various examples, ITLB 28 may comprise a copy of part of TLB 32. Alternatively, ITLB 28 and TLB 32 may be integrated. Similarly, in various examples of processor 10, I-cache 26 and D-cache 30 may be integrated, or unified. Further, I-cache 26 and D-cache 30 may be L1 caches. Misses in I-cache 26 and/or D-cache 30 cause an access to main (off-chip) memory 38, 40 by a memory interface 34. Memory interface 34 may be a master input to a bus interconnect 42 implementing a shared bus to one or more memory devices 38, 40 that may incorporate the improved data decompression in accordance with some examples of the disclosure. Additional master devices (not shown) may additionally connect to bus interconnect 42.

Processor 10 may include input/output (I/O) interface 44, which may be a master device on a peripheral bus, across which I/O interface 44 may access various peripheral devices 48, 50 via bus 46. Those of skill in the art will recognize that numerous variations of processor 10 are possible. For example, processor 10 may include a second-level (L2) cache for either or both I and D caches 26, 30. In addition, one or more of the functional blocks depicted in processor 10 may be omitted from a particular example. Other functional blocks that may reside in processor 10, such as a JTAG controller, instruction pre-decoder, branch target address cache, and the like are not germane to a description of the present disclosure, and are omitted for clarity.

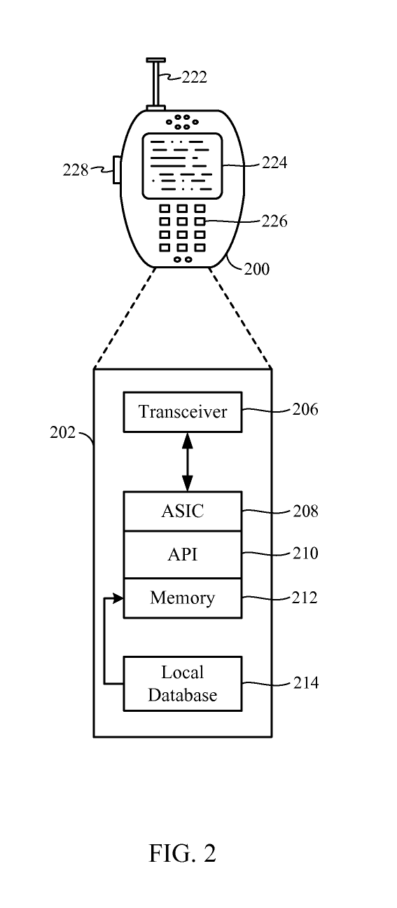

Referring to FIG. 2, a system 100 that includes a UE 200, (here a wireless device), such as a cellular telephone, which has a platform 202 that can receive and execute software applications, data and/or commands transmitted from a radio access network (RAN) that may ultimately come from a core network, the Internet and/or other remote servers and networks. Platform 202 can include transceiver 206 operably coupled to an application specific integrated circuit (“ASIC” 208), or other processor, microprocessor, logic circuit, or other data processing device. ASIC 208 or other processor executes the application programming interface (“API”) 210 layer that interfaces with any resident programs in memory 212 of the wireless device. Memory 212 can be comprised of read-only or random-access memory (RAM and ROM), EEPROM, flash cards, or any memory common to computer platforms. Platform 202 also can include local database 214 that can hold applications not actively used in memory 212. Local database 214 is typically a flash memory cell, but can be any secondary storage device as known in the art, such as magnetic media, EEPROM, optical media, tape, soft or hard disk, or the like. Internal platform 202 components can also be operably coupled to external devices such as antenna 222, display 224, push-to-talk button 228 and keypad 226 among other components, as is known in the art.

Accordingly, an example of the disclosure can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of UE 200 in FIG. 2 are to be considered merely illustrative and the disclosure is not limited to the illustrated features or arrangement.

The wireless communication between UE 200 and the RAN can be based on different technologies, such as code division multiple access (CDMA), W-CDMA, time division multiple access (TDMA), frequency division multiple access (FDMA), Orthogonal Frequency Division Multiplexing (OFDM), Global System for Mobile Communications (GSM), 3GPP Long Term Evolution (LTE) or other protocols that may be used in a wireless communications network or a data communications network.

Examples of the disclosure will now be described in the context of a Bluetooth Long file transfer, by way of illustration. It should be understood that the disclosure and inventive concepts disclosed herein are general in nature and may be applied to any wireless or wired technologies. The concepts described herein are especially suited when power and performance is degraded by a Tx underflow generated due to the protocol bottlenecks, especially in the conditions when the remote devices are slow and leads to too many flow controls, throttling, wastage of performance cycles and air time. The concepts can be applied in the above conditions, and such conditions could drain really high system currents with low priority traffic transmissions (like slow and long Bluetooth file transfers). Such scenarios can be seen in long transfers under several conditions such as a remote device is very slow in reception whereas the transmitter is really fast; a remote device has lesser Rx buffers adding to more flow control handshakes; an air channel is not good—leading to too many retransmissions/packet loss, especially if Interference/Intra-protocol coexistence issues are experienced; and a remote has a bad Rx.

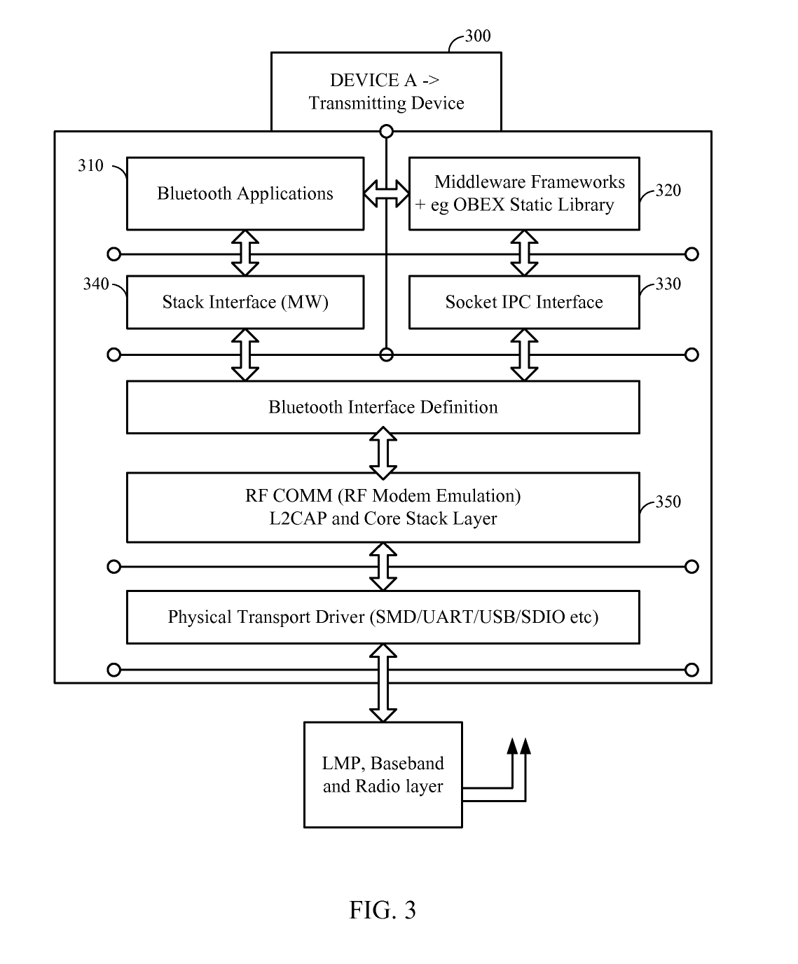

FIG. 3 depicts a Bluetooth long file transmission according to an example of the disclosure. In FIG. 3, a local device 300 includes various functional blocks that may make up a Bluetooth Open Source implementation are shown. In addition to the blocks (modules or components) described below, the local device 300 may include a Bluetooth Interface Definition 351, a Physical Transport Driver (SMD/UART/USB/SDIO etc.) 352, and a LMP, Baseband and Radio layer 352. Other blocks (modules or components) include:

Bluetooth Application 310: talks to the file system and delivers the digital data to the lower layers. This component may have the main responsibility of taking the data from a file system and then upon completion of the agreed packets, it holds the responsibility of telling the user of the progress of transfer. The Bluetooth Application may also tap the flow control received from an OBEX library and then may provide the next set of packets to the bottom layer.

OBEX Library 320: an OBEX Library 320 may deal with the data being read and written to/from the rfcomm socket provided via Socket Interface 330. This may hold the responsibility of packetizing the data in the OBEX format with necessary OBEX header additions, packetizing the PDUs for fitting the MTUs for OBEX negotiated with the remote ends. This component may manage the flow control mechanism between Application layer and Bluetooth Protocol stack during transfer. It should be noted that this layer may also have a flow control mode for RFCOMM based transfers. That is using two packets during the IO—one being a Final PUT PDU (this is not the final in terms of a full file but it is the final of that PDU set sum of the lengths of which constitutes one OBEX MTU) and other being a CONTINUE packet as an acknowledgement of the final PUT. Generally, the final put packet is sent after the OBEX MTU sized bytes have been transferred from the Tx side and the transmitter waits for the CONTINUE from the receiver under this condition. If the CONTINUE is not sent to the transmitter during the ongoing final put, then the transmitter considers that duration as “Obex Flow Stop”, even though more packets may be available and the rfcomm has credits to send the packet and the OBEX may not initiate the next packet transfer.

Stack Interface 340: There are two interfaces shown—one for each of the Bluetooth other profiles and one for the Standard SOCKET IPC 330 with Bluetooth protocol stack. The Bluetooth Stack Interface may be the interface that helps get the standard Socket pipe generated between the Applications and the RFCOMM. Stack Interface 340 acts like a middleware interface, and some instances optimize based on the detection of remote slowness/flow throttling in-line with the system Power being cut.

The interfaces during the transfer will now be described.

Bluetooth protocol stack component 350: This component may include two components—RFCOMM and L2CAP. The RFCOMM may be the modem emulation of the serial modem over virtual serial ports generally referred to as software virtual modem having the software handshakes for flow control mechanism during I/O. The RFCOMM also may have one more widely used mechanism during the transfer called CBFC or credit based flow control mode. The CBFC may be considered as software flow control mechanism agreed during the transfer especially the receiver's credits known at the connection time. The Tx side may have to keep a note of the receiver's max credits and how deep buffers are at the remote rfcomm (=max credits*port mtu) size deep. Once achieved and no credit updates received from remote, it is considered as a “flow-stop” condition and may not transfer any data over RFCOMM even though it has packets available on the OBEX socket.

CPU Governor: The role of CPU Governor may be in the overall power and performance driven mode. The CPU governor may be the module that is a sensitive module doing the calculation on each of four cores 0-3 and then accordingly does the Frequency Jumps and also CPU Jumps to meet the processing demands of the applications under execution. The governor goes to high CPU speeds generally to maintain a good user experience in terms of latency offered by the CPU or the platform in order that the user inputs are not delayed during the idleness or sleep time. The governor (an illustrative configuration) may use with the following rules:
It jumps to the higher modes of the CPU Speeds e.g. 1.2 GHz on Single Core the moment 90% of the minimum frequency (e.g. 300 MHz) has been achieved at a given time.
The above-said 90% may not just include the example specified, but it may include the sum of the overall CPU usages on the system at that given time, which may as well be close to 90% of the 300 MHz for example.
the baseline for the jump is 90% of 300 MHz for example.
Once this is reached by the running applications, the bumping is done to the turbo modes where the voltages and currents are really high at the battery to deliver the best user experience. The bumps are done by the system so that the user does not see any slowness but has a negative impact on the power consumption.
such bumps to turbo modes should be avoided for low priority traffic especially under the waiting conditions.
Such bumps to turbo should only happen on critical user specific scenarios and not for background low priority traffic like a huge file transfer case on any protocol.

CPU Governor vs. User Data Flow Stops: As explained previously, the relation of the high power conditions to that of user data flows is direct due to sudden underflows and resumption of traffic during ongoing data flow. The root cause of the high power during the slow and bursty remote traffic may be the governor detecting the traffic right after the underflow as 90%+of the a minimum frequency (e.g. 300 Mhz) baseline.

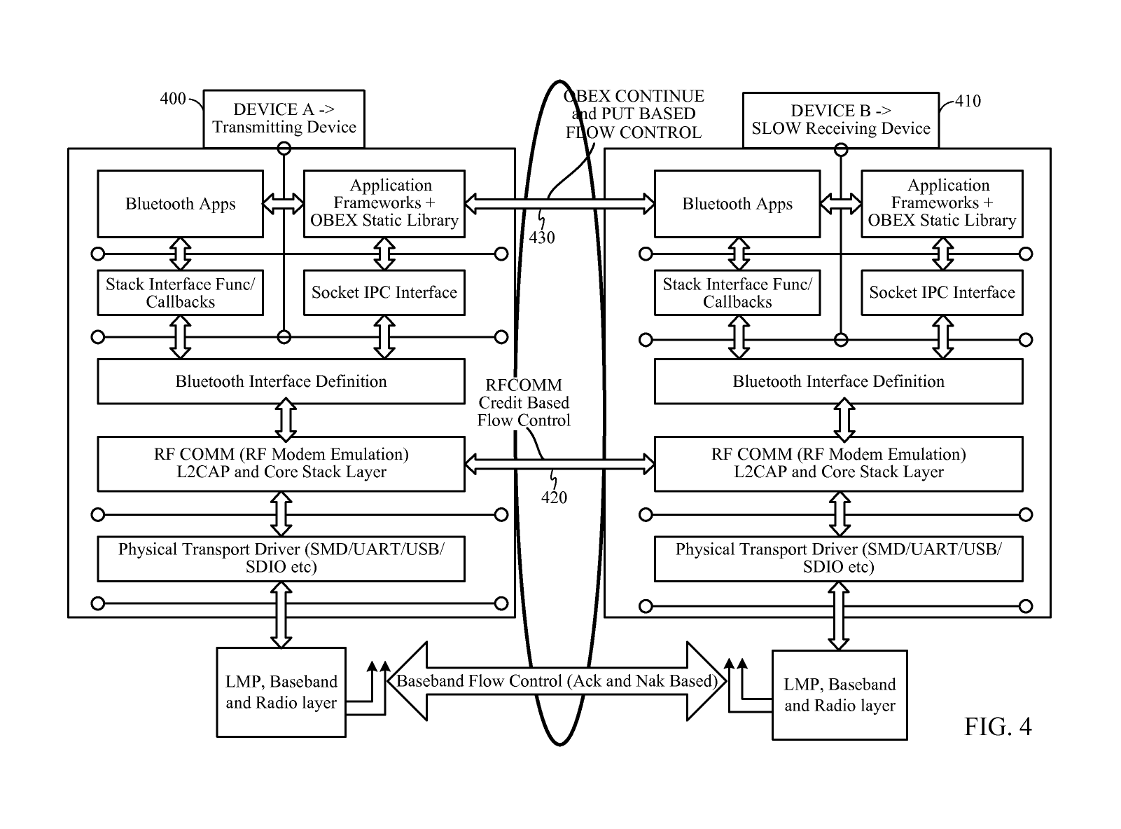

Protocol Flow Control: Bluetooth protocol flow control mechanisms at different layers are illustrated in FIG. 4 for communication between a local device 400 and a remote device 410.

Flow controls: There may be two flow controls that are directly impacting the Power and performance modes of the operation. RFCOMM Credits 420 (negotiated Rx max credits) transmitter does not send any packets unless Credits are available from the remote. CONTINUE 430 packets on OBEX that are to be awaited to send the data to the other end.

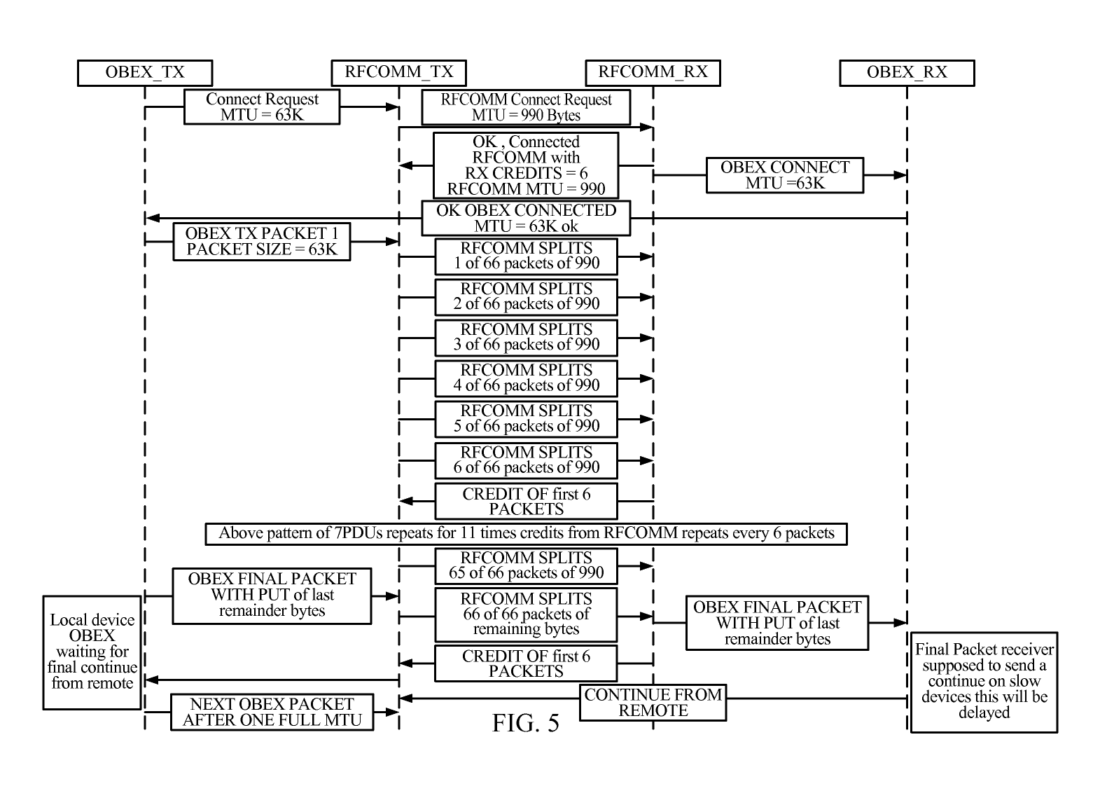

FIG. 5 illustrates an exemplary sequence that highlights the bottleneck that causes the speeds to dip especially if the remote delays the continue packets. As can be seen, there is a latency of 58 to 110 milliseconds per CONTINUE 500 that cause the speed drop/underflow between the OBEX FINAL PACKET WITH PUT of last remainder bytes block 510 and the NEXT OBEX PACKET AFTER ONE FULL MTU block 520. Also, this latency happens every time the remote does a delay in either CONTINUE or RFCOMM CREDITS. The latency causes the following a) data not sent from OBEX to RFCOMM, even though RFCOMM has credits available to send some more packets, b) speeds drop (since the latency is to the tune of 58 to 110 milli-seconds every CONTINUE or after every MTU Transmission), and c) the uneven bit per second—leading to sudden increase in CPU speeds after underflow.

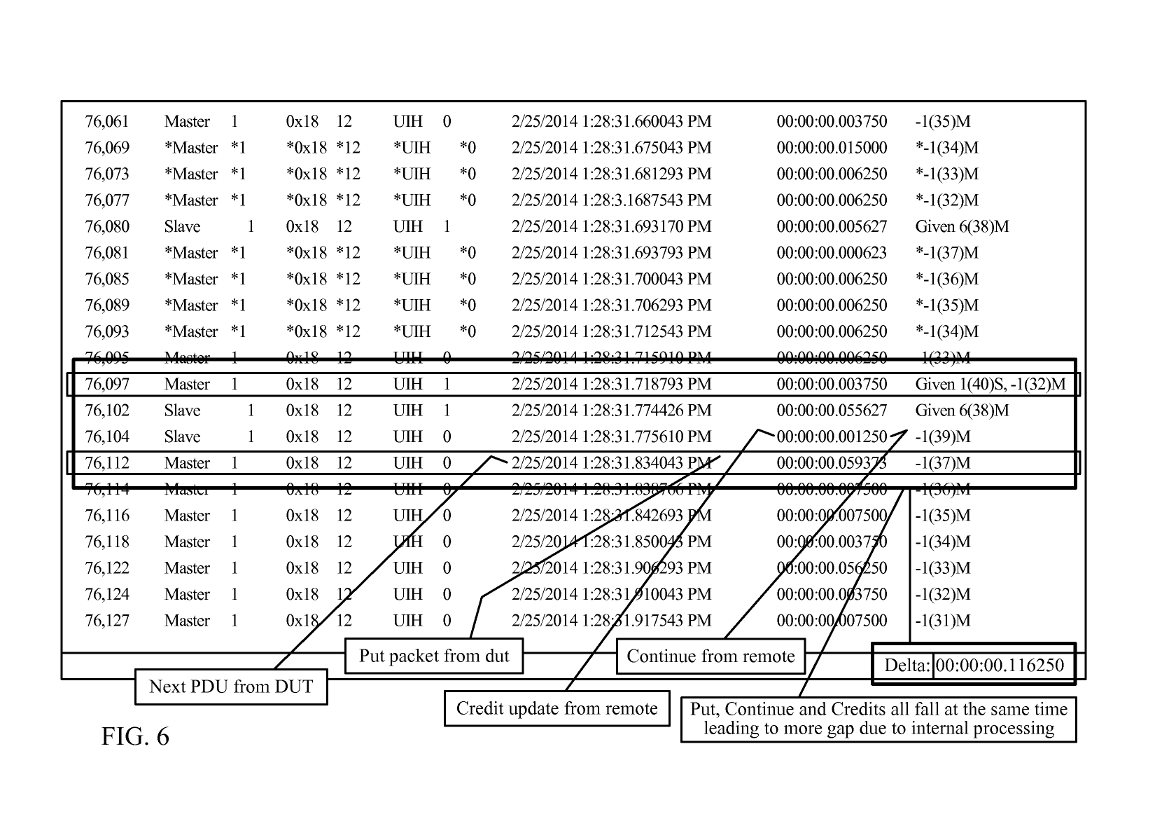

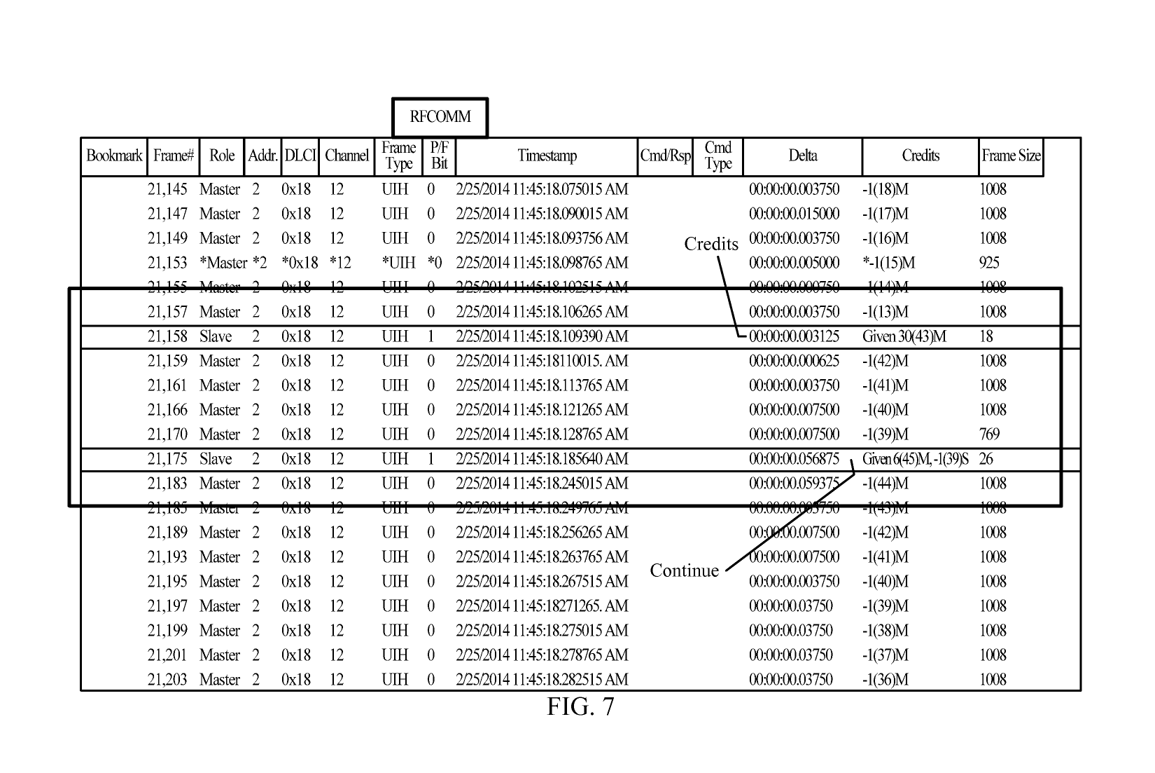

FIG. 6 illustrates exemplary Put 600 (final of that PDU Lot, equal to one OBEX MTU size), Continue and RFCOMM Credits for Flow Control Off and On. FIG. 7 illustrates exemplary Continue 700 and RFCOMM Credits 710.

The relation of the Flow OFF/Traffic resumption to Battery Power will now be described. This may be a CPU speed governor software code with MP Decision linkage by way of illustration. The linkage to the power may be in terms of the irregular rate of data transmission due to the slow remote. The WCNSS may get lesser data from the host since being throttled by the slow remote device. Sampled power traces show that the POWER Rails of WCNSS sees underflows at very frequent intervals and then once the traffic starts, a sudden spur of traffic. This spur may lead to sudden CPU load variation and hence the governor tries the higher frequencies to cater to this load. The APPS current value may go up the moment underflow on WCNSS Ends, and the traffic resumes. This may lead to a high current with the throttled network.

In certain scenarios, a variable data rate may cause problems. However, with the remote device that has higher buffers to receive and less of throttling happening during transfer, the main power is unlikely to experience a problem because the Application Processor power does not go in steps - leading to lesser power numbers. The CPU behaves in a consistent manner since the remote is fast enough and not much of ups and downs are seen in the bit rate or speeds due to higher buffers on the remote receiver. Thereby the average current over a period of time is a bit low.

In an exemplary scenario where Inject Flow offs affecting the power numbers will now be described. For example, when the remote has lower Rx buffers and also throttles regularly, this may lead to very high ups and downs in the CPU utilization of the Application Processor specifically if during the underflows the idle thread's CPU utilization is curbed down.

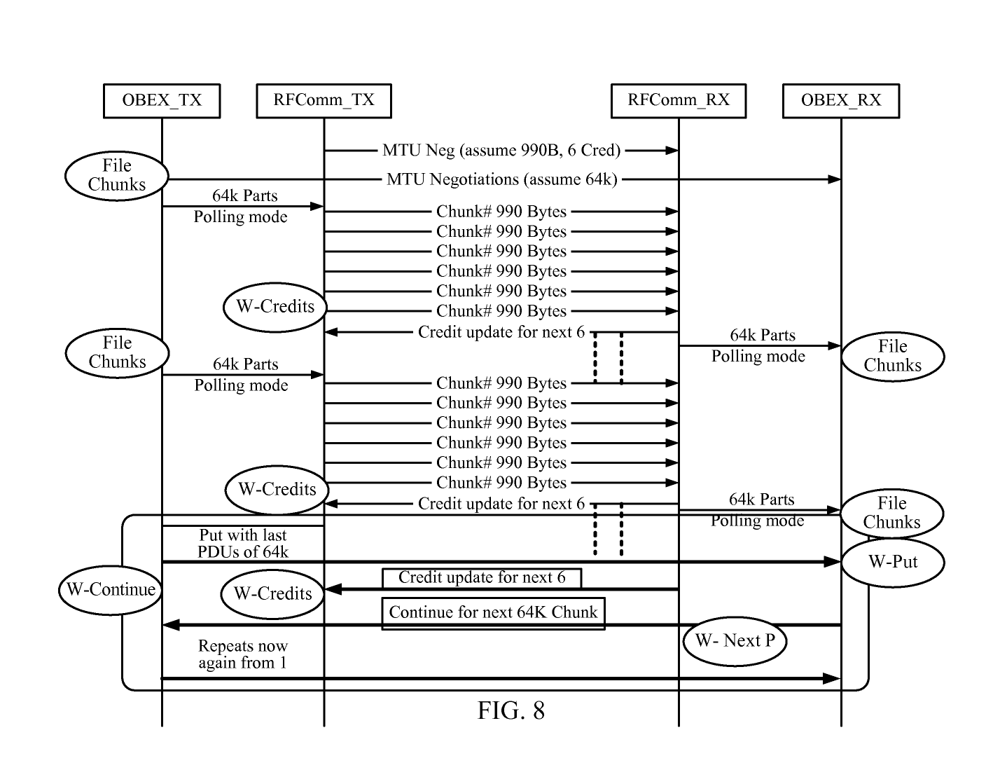

FIG. 8 depicts OBEX 800 and RFCOMM Tx 810 and Rx 820 interactions.

Various exemplary scenarios are described below that depict how some examples of the disclosure save power and balance performance. Scenario one—a slow and variable remote side receiver during transfer that cannot be changed. As described above, the flow would not be always ON especially when we have one of the following three conditions:
Low remote buffers for reception (e.g., less than 5-6 packets) and the transmitter is really fast
the remote device is slow
Or the channel is really bad and we are retransmitting at the Bluetooth Baseband level where the Application Processor is idle

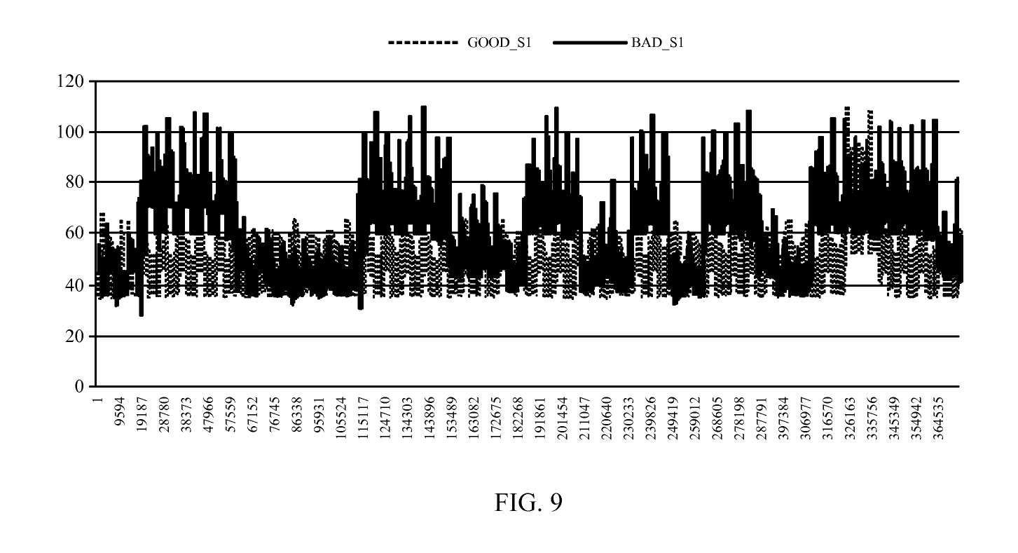

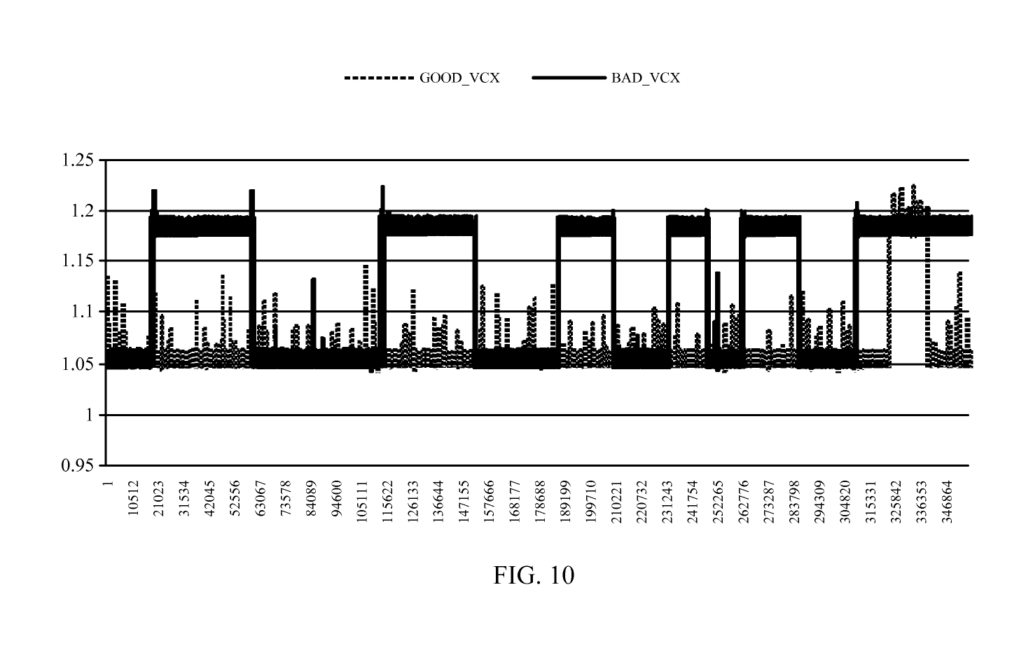

Under such a scenario, huge amounts of currents may be consumed without detection as seen in the rail diagrams of FIGS. 9 and 10. FIG. 9 depicts the current on the CX rail. FIG. 10 depicts the voltage on CX Rail.

In a bad case; VCX is going to 1.18 Volt (Turbo mode) whereas in a good case; it remains at 1.05 Volt for most of the time.

In another scenario—low priority traffic moves the system power higher due to a variable rate flow. In this case, the traffic is not a very high priority and only long transfer should go at a speed in excess of an example 1.4 Mbps (this is just an example and highly platform dependent) and should not drop during long transfers.

In another scenario—the CPU governor tunings cannot be changed and the MP Decision cannot be disabled (this is because we will have a reverse impact on the reactivity of the system to other sensitive usage scenarios). The governor and MP Decisions may be modeled per target and may be fine tune to have the particular sampling values and the slack timings per CPU.

Because of such fine tunings, it is difficult to have that algorithm changed for the low priority traffic without the user experience being hit for high priority use cases such as audio and touch/gaming etc. For example, the MP Decision and the CPU governor have been tuned to have following features:
Intermediate Hi-Frequency.
Interactive governor comes with an option of configuring an Intermediate high-speed below the max speed. The frequency jumps to this speed as soon as the high-speed load is crossed. There is configurable delay time.
There is a predefined wait time before the Step jumps in the CPU Frequencies could happen based on the load evaluation after this delay.
Fine tunings for audio over Bluetooth or the touch or some more time critical scenarios where it does not switch too often to make the performance better
TouchScreen Boost: The Input event patches from different vendors seems to have got consolidated into one solution.
Others: Default minimum sample time changed to around a few milli seconds, after which we can ramp down the steps as well if the load evaluated by the software thereof has gone below a given threshold
A modeled value of such a thing is generally hardwired and then not changed as they may impact the overall system aspects. Hence we need to model our speeds rather than changing the system policies to lower the speeds in the scenarios mentioned.

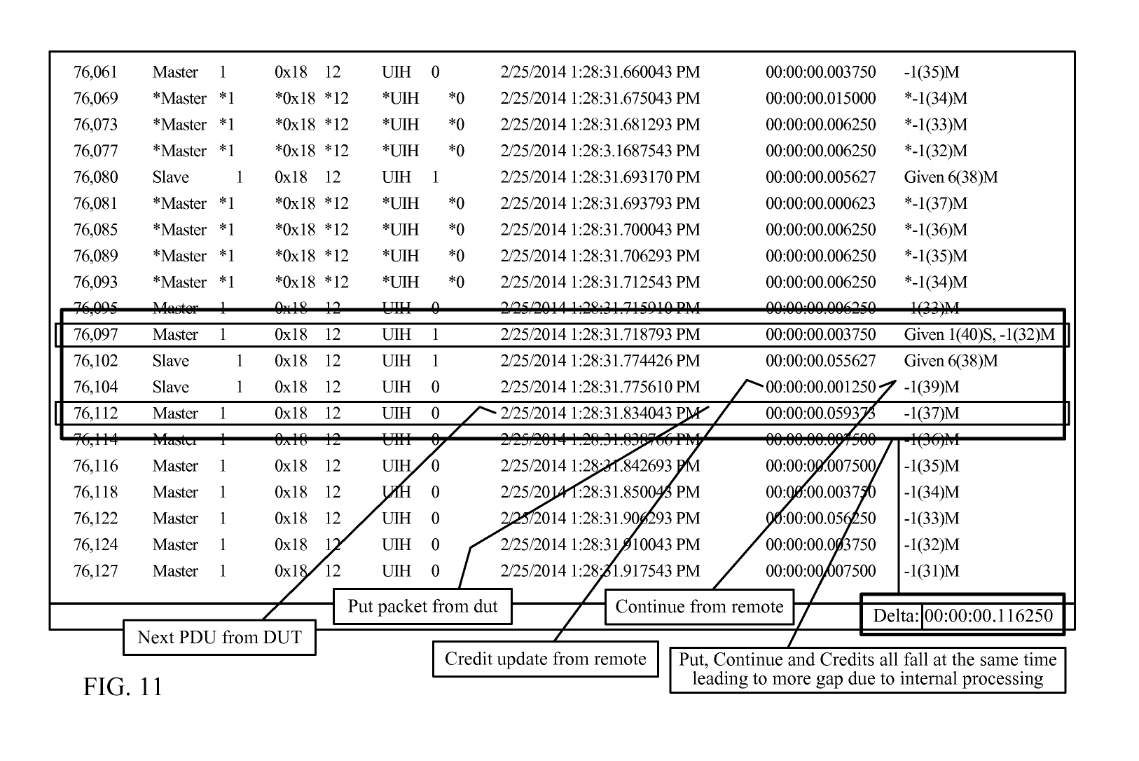

MTU adjustment for reduction of the probability of a handshake collision and credit processing will now be described. The timeline as shown in the diagram practically falls in excess of 110 milliseconds and is wasted time in terms of data speeds since this is just a handshake and not data. As shown in FIG. 11, this is a problematic case. Although the speed is a bit high, the real problem is that there is a big wait time since on every eleven packets, the continue packet from the remote and RFCOMM CREDITS from the remote are coming at almost the same time. This is because every six packets, the remote will send a credit. The OBEX PDU Side would be =65534 bytes, which generally will be split into, for example, 65*990 bytes (RFCOMM MTU) +1 packet remaining Thus, every 66 packets will see one put from DUT to the remote and at the same time, the six credits have to be given to the DUT from remote that it is processing. A Put is sent that has to be processed and a CONTINUE is sent as well. Now every eleventh (=66/6) Credit update, PUT, CONTINUE and CREDITS are being processed thus leading to more SOC Underflow during that time.

In the above scenario, a local MTU adjustment may lead to a solution. Assume the RFCOMM credits of the remotes to be low (in our example it is as low as six Credits), which means that every six packets that the remote receives, it will give a credit to the transmitter and then the Tx side can make further transfers. To have an improvement in current, the Credits and Continue by may be staggered by either of the two ways:
Make the Tx MTU as a non-multiple of the number of remote Rx credits (Remote side diff of RFCOMM WM MAX-MIN)
Adjust the Tx MTU to a value which lets CONTINUE come before or after Credits (not overlap)

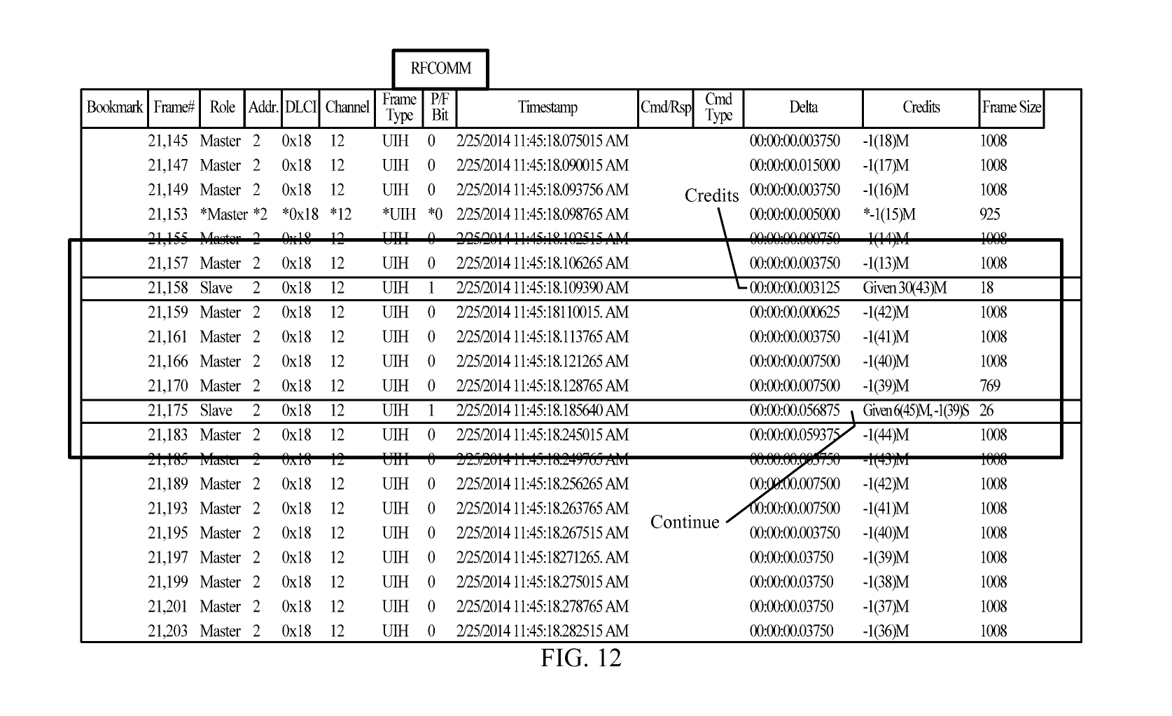

The first target may be to have the staggering as shown in FIG. 12. This shows that with the suggested approach for runtime MTU adjustment would let the handshakes un-stagger over the time space and overcomes the issue reported in the FIG. 11 by adjustments done at run time per set of PDUs, saves more than 100 milliseconds hence increases speeds without impacting much power) As shown in FIG. 12, a savings of 55+ ms of the delays on every eleven Credit Updates may be achieved.

Pacing the low priority traffic periodically even during the underflow will now be described. Since the pace of data transfer (in Bits per Second) is not constant, there is a sudden dip in Tx activities intermittently and the CPU governor randomly kicks in and tries to bring down frequency and voltage. However, the real issue comes after the data is suddenly available and the governor tries to assess the CPU load. There may be a sudden rise in the CPU utilization and the governor jumps the CPU to the higher frequency thus going back to the higher power consumption. This may lead the system to go to the turbo mode without even having very high priority or high traffic conditions.

Capping the maximum frequency and disabling the MP Decision will now be described. By disabling the Microprocessor frequency Switch Decision on the system and cap the MAX CPU speeds to example 600 Mhz instead of going to top speed of 1.2 Ghz, the power numbers may be acceptable and within range. With Microprocessor frequency Switch Decision stopped and limited maximum frequency to example 600 MHz, there are no spikes or sudden increase in current throughout.

Some examples of the disclosure solve the above problem by three components:
achieving low power goals; achieving high performance goals; and balancing for low priority traffic.

### Low Power Goals

Provide the OBEX MTU that does not invite the Collision (all handshakes and PDUs almost falling in almost same time frame) of other processing as explained above.

Pace out the Transfer in such a way that the governor does not notice too many fluctuations in the data transfer rate. Under this condition there may be max power save since then the governor would be seeing a constant medium speeds and will not jump across the ramps. Secondly, this may have a Speed penalty if the transfer is too slow and the flow off situations are ignored.

So the MTU adjustment at run time, in such a way that it staggers the several handshakes over time, will really help streamline all threads and also not allow a lot of underflow to happen frequently.

The root cause of the issue as we discussed earlier lies in the hands of the CPU-Frequency governor code which suddenly sees the high CPU usage after each underflow conditions.

After each underflow condition, a sudden spike in the CX Current occurs in steps. These step spikes are seen because the CPU Governor sees a sudden usage of CPU but a gradual hike in the % of CPU utilization. Some examples of the disclosure that reduce the power numbers may have a drawback in that the speeds may be down about 15% or more for example.

HIGH PERFORMANCE GOALS: the OBEX Tx speeds may be hampered by the

UNDERFLOWS and the packets pumped after the underflow recovery suddenly at higher speeds. The performance boosts may occur when few data packets (under max remote credits) are pumped during the remote continue delays. As explained previously, the underflows have two drawbacks, one is that it dips the bits per second of the transmission rate and secondly during the dip kicks the governor in and it tries to come to a lower level of its CPU frequencies. However, in Bluetooth the underflows are not for a long duration of time, especially when a single link is under consideration. This underflow puts down the CPU frequency if too long (could span up to or more than around 100 ms+) but then the moment traffic starts, a sudden spur in the frequency of the cores occurs, which may be avoided to save power.

The low power goal may be achieved if the pace of the traffic from rfcomm is controlled in such a way that the CPU governor code sees it as a minor increase until the next flow off is hit.

Now the underflow situation will be discussed and how to make use of such a scenario to merge with low power goals and have a tradeoff between Power and Performance. To have the utilization of traffic during the continue delays, the underflows may be used to increase the Speeds and also to pace out the traffic after continue, this may lead to a good balancing between the speeds and power consumption.

The underflow area may still be useful where the system is waiting for a CONTINUE but the rfcomm credits are available. In such a case, Agreed credits minus one or two packets during the underflow are pushed. This may allow not only utilizing the underflow (speed increase) but also allows pace out of the packets just after the underflow.

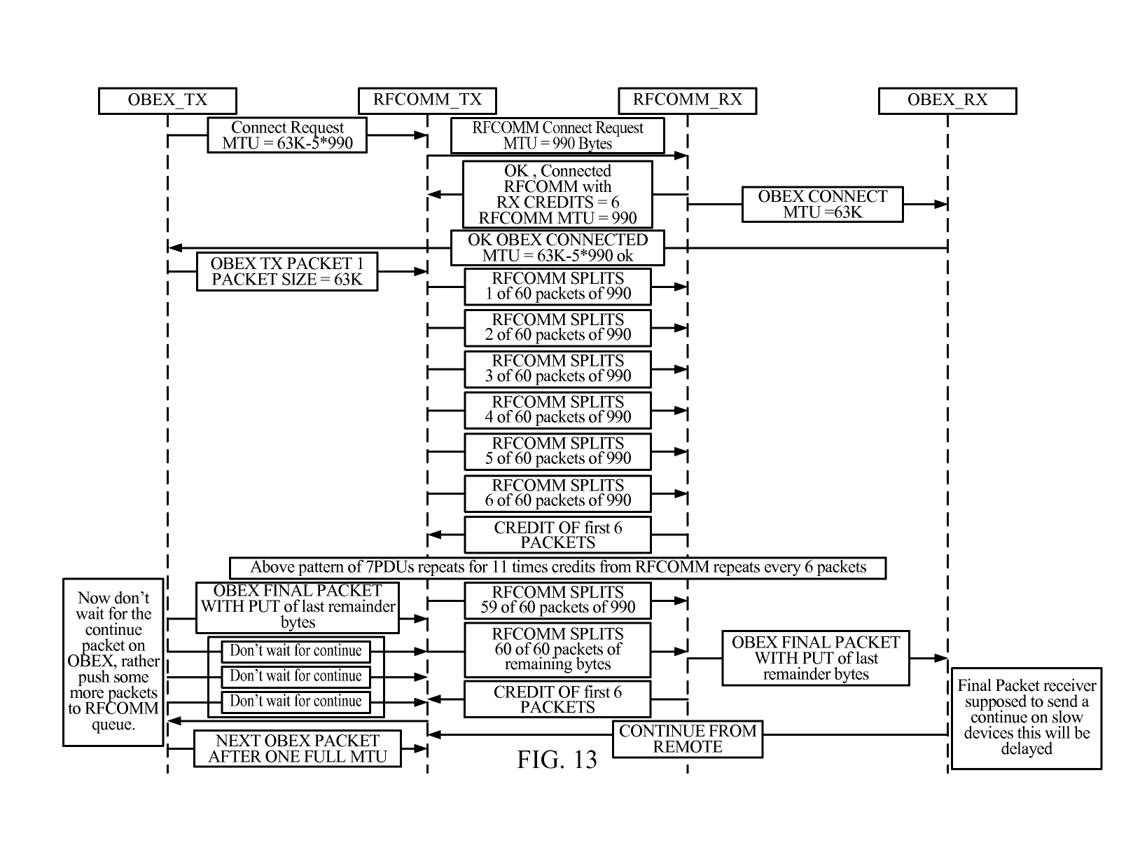

FIG. 13 illustrates some example examples of the disclosure that have the changes in the packetizing scheme from that shown in FIG. 3. As can be seen, there is a latency of 58 to 110 milliseconds per CONTINUE that cause the speed drop/underflow between the OBEX FINAL PACKET WITH PUT of last remainder bytes block and the NEXT OBEX PACKET AFTER ONE FULL MTU block. Also, this latency happens every time the remote does a delay in either CONTINUE or RFCOMM CREDITS. The latency causes the following a) data not sent from OBEX to RFCOMM, even though RFCOMM has credits available to send some more packets, b) speeds drop (since the latency is to the tune of 58 to 110 milli seconds every CONTINUE or after every MTU Transmission), and c) the uneven bit per second—leading to sudden increase in CPU speeds after underflow. For example:
Reduce the OBEX MTU by an amount (about a max of max receivers OBEX MTU—5 packets, assume 6 packets between 2 Rx-Credit frames)
5 packets mentioned so that we don't hit a collision case if credit update if we go up to the 6 even in the underflow conditions
This is based on the assessment that we anticipate that the remote is slow and the handshake is going to come back in some time.
Plan all the sixty odd packets in the normal way and send the final PUT in the normal way
Do not wait for the continue at the obex level, just put these five packets during the underflow time into the rfcomm queue and thereby onto the transport level so that the CPU governor still doesn't kick the Microprocessor Step change decision in the meantime.
Moment the credits are received from remote, we can pump these packets over the air to the remote controller's buffers. Thereby saving time between the RFCOMM Credits and CONTINUE wait times.
As soon as the rfcomm queue receives the credits, these will be sent and no waiting for the continue is needed to start queuing, thereby reducing the CPU Load effectively not letting the CPU Frequency jump happen.
This may effectively increase some more bits per seconds when the underflow occurs
To have a speed impact this change may be needed
To have a power impact, a proper balance between the extra packets queued before continue is really received may be needed.
Thus, the governor does not come down too often and, subsequently, the need to maintain the bits per second for another few packets after underflow is finished
This may result in a good tradeoff in speed versus power.

Examples of the methods, apparatus, and systems described herein can be used in a number of applications. For example, the described examples could be used in wireless or wired systems that generate a burst of digital traffic across the multiple processors. Further applications should be readily apparent to those of ordinary skill in the art.

Nothing stated or illustrated depicted in this application is intended to dedicate any component, step, feature, benefit, advantage, or equivalent to the public, regardless of whether the component, step, feature, benefit, advantage, or the equivalent is recited in the claims.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method step or as a feature of a method step. Analogously thereto, aspects described in connection with or as a method step also constitute a description of a corresponding block or detail or feature of a corresponding device. Some or all of the method steps can be performed by a hardware apparatus (or using a hardware apparatus), such as, for example, a microprocessor, a programmable computer or an electronic circuit. In some examples, some or a plurality of the most important method steps can be performed by such an apparatus.

The examples described above merely constitute an illustration of the principles of the present disclosure. It goes without saying that modifications and variations of the arrangements and details described herein will become apparent to other persons skilled in the art. Therefore, it is intended that the disclosure be restricted only by the scope of protection of the appended patent claims, rather than by the specific details presented on the basis of the description and the explanation of the examples herein.

In the detailed description above it can be seen that different features are grouped together in examples. This manner of disclosure should not be understood as an intention that the claimed examples require more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods disclosed in the description or in the claims can be implemented by a device comprising means for performing the respective steps or actions of this method.

Furthermore, in some examples, an individual step/action can be subdivided into a plurality of sub-steps or contain a plurality of sub-steps. Such sub-steps can be contained in the disclosure of the individual step and be part of the disclosure of the individual step.

While the foregoing disclosure shows illustrative examples of the disclosure, it should be noted that various changes and modifications could be made herein without departing from the scope of the disclosure as defined by the appended claims. The functions, steps and/or actions of the method claims in accordance with the examples of the disclosure described herein need not be performed in any particular order. Furthermore, although elements of the disclosure may be described or claimed in the singular, the plural is contemplated unless limitation to the singular is explicitly stated.

What is claimed is:

1. A mobile device, comprising:
a data application module for generating data packets;
a protocol stack component for transmitting the data packets to a remote device at a transmission flow rate, the protocol stack communicatively coupled to the data application module;
an OBEX component for sending flow control messages, the OBEX component communicatively coupled to the data application module and the protocol stack component to send the flow control messages to the data application module and the protocol stack component;
a processor for controlling a process flow of the data application module, the protocol stack component, and the OBEX component; and
a governor for controlling a processor speed of the processor,
wherein the OBEX component sends a data size flow control message to the data application module to control a size of the generated data packets based a number of remote transmission credits received from the remote device.

2. The mobile device of claim 1, wherein the governor decreases the processor speed during an overflow condition in the remote device.

3. The mobile device of claim 2, wherein the governor maintains the decreased processor speed after the overflow condition is terminated.

4. The mobile device of claim 1, wherein the governor increase the processor speed during an underflow condition in the remote device.

5. The mobile device of claim 4, wherein the governor maintains the increased processor speed after the underflow condition is terminated.

6. The mobile device of claim 1, wherein the transmission flow rate is adjusted based on the remote device rate of data reception.

7. The mobile device of claim 1, wherein the governor disables a processor speed switch decision and sets a maximum processor speed during an overflow condition.

8. The mobile device of claim 1, wherein the OBEX component detects a low remote transmission credit condition and delays a continue flow control message transmission in response thereto.

9. The mobile device of claim 1, wherein the OBEX component adjusts the size of the generated data packets to allow a continue flow control message to arrive at a time different than an anticipate arrival of a remote transmission credit message.

10. A transmitter comprising:
a transmitter for transmitting data packets to a receiver;
a data transmission governor in communication with the transmitter, the data transmission governor configured to control a transmission speed of the transmitter; and
a data flow component in communication with the transmitter, the data flow component configured to generate data packets for transmission and communicate the generated data packets to the transmitter for transmission.

11. The transmitter of claim 10, wherein the transmitter is integrated into one of a mobile phone, a mobile communication device, a pager, a personal digital assistant, a personal information manager, a mobile hand-held computer, a laptop computer, a wireless device, or a wireless modem.

12. The transmitter of claim 10, wherein the data transmission governor adjusts the transmission speed of the transmitter based on a reception rate of the receiver.

13. The transmitter of claim 12, wherein the data flow component adjusts a size of the generated data packets to allow a continue message from the receiver to arrive at a time different than an arrival time of a credit message from the receiver.

14. The transmitter of claim 13, wherein the data transmission governor detects a low transmission credit condition and delays transmission of a continue message to the receiver in response to the detected low transmission credit condition.

15. The transmitter of claim 14, wherein the data transmission governor decreases a processor speed during an overflow condition in the receiver.

16. The transmitter of claim 15, wherein the data transmission governor maintains the decreased processor speed after the overflow condition is terminated.

17. The transmitter of claim 16, wherein the data transmission governor increases the processor speed during an underflow condition in the receiver.

18. The transmitter of claim 17, wherein the data transmission governor maintains the increased processor speed after the underflow condition is terminated.

19. The transmitter of claim 18, wherein the data transmission governor disables a processor speed change decision and sets a maximum processor speed less than a maximum speed of a transmitter processor.

20. A method of communication between a local device and a remote device, comprising:
controlling a microprocessor frequency jump decision component of a local device based on a controller underflow condition;
controlling a processor load of the local device when a transmitter of the local device is waiting for a handshake message from a remote device;
detecting the controller underflow condition at a run time; and
adjusting a maximum transmission unit of the local device to reduce a probability of handshake collision and credit processing.

21. The method of claim 20, wherein controlling the microprocessor frequency jump decision component includes preventing an increase in a processor speed.

22. The method of claim 21, wherein controlling the microprocessor frequency jump decision includes decreasing the processor speed during the controller underflow condition.

23. The method of claim 22, wherein controlling the microprocessor frequency jump decision includes maintaining the decreased processor speed after the controller underflow condition is terminated.

24. The method of claim 23, further comprising detecting a low remote transmission credit condition and delaying a continue flow control message transmission in response thereto.

25. The method of claim 24, further comprising adjusting a size of data packets to allow a continue flow control message to arrive at the local device at a time different than an arrival time of a remote transmission credit message.

26. The method of claim 25, further comprising disabling a microprocessor frequency jump decision and setting a maximum processor speed during a controller overflow condition.

27. An article of manufacture comprising a computer-readable storage medium having program code for controlling communication between a local device and a remote device, the program code comprising instructions that, when executed by a processor, cause the processor to perform operations comprising:
controlling a microprocessor frequency jump decision component of a local device based on a controller underflow condition;
controlling a processor load of the local device when a transmitter of the local device is waiting for a handshake message from a remote device;
detecting the controller underflow condition at a run time; and
adjusting a maximum transmission unit of the local device to reduce a probability of handshake collision and credit processing.

28. The article of manufacture of claim 27, wherein controlling the microprocessor frequency jump decision component includes preventing an increase in a processor speed.

29. The article of manufacture of claim 28, wherein controlling the microprocessor frequency jump decision includes decreasing the processor speed during the controller underflow condition.

30. The article of manufacture of claim 29, wherein controlling the microprocessor frequency jump decision includes maintaining the decreased processor speed after the controller underflow condition is terminated.
